(19) United States
(12) Patent Application Publication
(10) Pub. No.: US 2026/0205455 A1
(43) Pub. Date: Jul. 16, 2026

(54) STRUCTURED AUTHENTICATION IN A DISTRIBUTED SYSTEM

(71) Applicant: Dell Products L.P., Round Rock, TX (US)

(72) Inventors: ERIC RANDAL YOUNG, Alexandria, VA (US); TAMILARASAN JANAKIRAMAN, Cork (IE); CHARU LATA OJHA, Cork (IE)

(21) Appl. No.: 19/025,838

(22) Filed: Jan. 16, 2025

(51) Int. Cl. H04L 9/40

(52) U.S. Cl. CPC H04L 63/10; H04L 63/08; H04L 63/205

(57) ABSTRACT

Methods and systems for managing operation of a system are disclosed. The operation may be managed by identifying a level of privilege of an entity requesting that a data processing system of the system perform a portion of computer-implemented services. The level of privilege may be identified using an authentication system that obtain at least one policy maintained for the data processing system. The authentication system may identify whether conflicts exist between the at least one policy and harmonize the at least one policy if a conflict exists. The harmonized policy may be used to identify a level of privilege of the entity.

### FIELD

Embodiments disclosed herein relate generally to managing operation of a system. More particularly, embodiments disclosed herein relate to verifying privilege of an entity requesting computer-implemented services to be performed by the system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIG. 2 shows a data flow diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services. To provide the computer-implemented services, various components of an infrastructure (e.g., a container orchestration platform) may perform various actions and communicate with one another. Such communication and actions may serve as a vector of attack on the infrastructure and/or data processing systems of the infrastructure.

To reduce a likelihood of the attack, a system in accordance with an embodiment may utilize an authentication system for verifying integrity of communications and authority of entities for requesting data and/or actions via an authentication request. Based on the authentication request, the authentication system may obtain security policies defined for the components (e.g., an orchestrator, a container, an application, etc.) that provide a desired portion of the computer-implemented services.

Because at least one policy conflict may exist between the security policies for each component, the authentication system may harmonize the security policies to obtain a harmonized set of policies with a consistent set of rules. For example, a lowest privilege level for data access may be applied to all components when at least one component may typically grant a higher privilege level. Additionally, because each component may utilize a different authentication mechanism, the authentication system may identify a predefined authentication flow based on the authentication request and the harmonized set of policies for validating the authentication request.

By doing so, the infrastructure may be less likely to be compromised while working cooperatively to provide desired computer-implemented services. Thus, embodiments disclosed herein may address, in addition to others, the technical problem of security in a distributed system where the security of any of the components of the distributed system may be compromised thereby providing an avenue of attack on other components of the infrastructure.

In an embodiment, a method for managing a system that provides computer-implemented services is provided. The method may include: (i) obtaining, by an authentication system of the system and from a data processing system of the system, a privilege verification request for an entity that has requested that the data processing system perform a portion of the computer-implemented services; (ii) obtaining by the authentication system and from at least one other authentication system, at least one policy based on the privilege verification request; (iii) identifying whether any conflicts between the at least one policy exists; (iv) in a first instance of the identifying where at least one conflict between the at least one policy exists: (a) harmonizing the at least one policy to identify a level of privilege of the entity; (b) harmonizing the at least one policy to identify a level of privilege of the entity; and (c) managing operation of the data processing system using the privilege verification outcome to facilitate provisioning of desired computer implemented services.

The authentication system may be adapted to use at least one authentication mechanism to process the privilege verification request.

The at least one authentication mechanism may include at least one selected from a list of authentication mechanisms consisting of: (i) credential-based authentication; (ii) certificate-based authentication; (iii) token-based authentication; and federated authentication.

The at least one other authentication system may maintain at least one local policy used to define a level of privilege for at least one data processing system of the system.

The authentication system may communicate with the at least one other authentication system to obtain the at least one local policy based on the privilege verification request.

Identifying whether the at least one conflict exists may include: (i) comparing a set of rules corresponding to a first policy of the at least one policy to a second set of rules corresponding to a second policy of the at least one policy; (ii) making a determination regarding whether the first set of rules and the second set of rules comprises at least one mutually exclusive rule; and (iii) in a first instance of the determination where the first set of rules and the second set of rules does comprise at least one mutually exclusive rule: (a) concluding that a conflict exists.

Harmonizing the at least one policy may include: (i) identifying a desired set of rules, between the first set of rules and the second set of rules, using criteria; and (ii) defining a harmonized set of policies using the desired set of rules.

The criteria may include a lowest level of privilege for data access.

Identifying whether the entity has sufficient privilege may include: (i) identifying a predefined authentication flow based on the privilege verification request and the level of privilege of the entity; and verifying the privilege verification request using the predefined authentication flow to obtain the privilege verification outcome.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

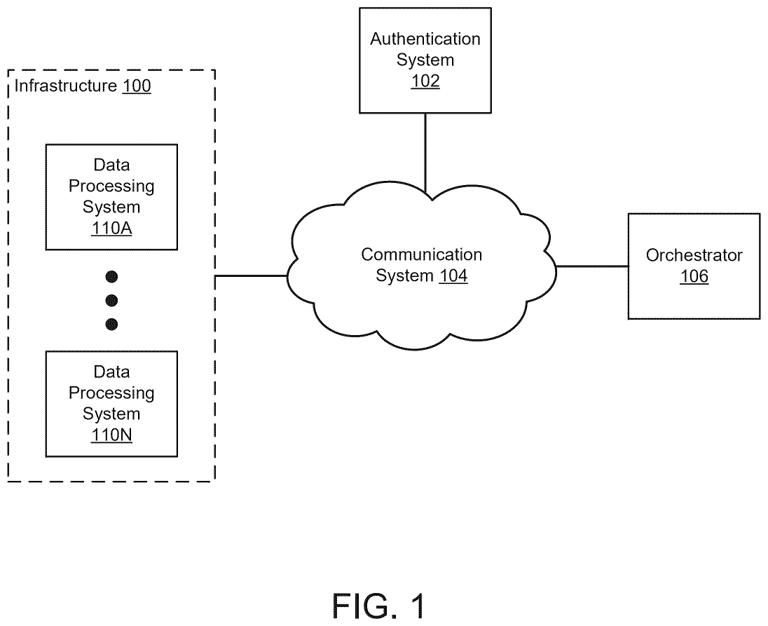

Turning to FIG. 1, a block diagram illustrating a system in accordance with an embodiment is shown. The system shown in FIG. 1 may provide any type and quantity of computer-implemented services (e.g., to user of the system and/or devices operably connected to the system).

The computer-implemented services may include, for example, database services, data processing services, electronic communication services, and/or any other services that may be provided using one or more computing devices. The computer-implemented services may be provided by, for example, infrastructure 100, authentication system 102, orchestrator 106, and/or any other type of devices (not shown in FIG. 1). Other types of computer-implemented services may be provided by the system shown in FIG. 1 without departing from embodiments disclosed herein.

To provide the computer-implemented services, the system may include various distributed components. The components may cooperate to provide at least a portion of the computer-implemented services. For example, any number and/or type of data processing systems (e.g., 110) may be configured in an infrastructure (e.g., 100) to host resources and/or perform workloads (e.g., via containers).

To cooperate, the components may send messages to one another. The messages may include information regarding actions to be performed, information used in performing actions, and/or other types of information that may be used to request performance of a portion of computer-implemented services. Communication of the messages may be initiated by a user of at least one data processing system (e.g., 110A) via a user interface, an application hosted by a data processing system, and/or any other entity.

However, malicious entities may attempt to compromise various components of the infrastructure by sending various messages. The message may appear to be from legitimate sources. Consequently, the components of the distributed system may act on these messages. Such actions may result in the computer-implemented services provided by the system to be compromised, the components themselves to be compromised, and/or other components that interact with the system to be compromised.

To reduce a likelihood that the infrastructure may be compromised, a system may utilize an authentication system for verifying a level of privilege of an entity requesting that a data processing system perform a portion of computer-implemented services. Based on the privilege verification request, the authentication system may obtain policies defined for the components (e.g., an orchestrator, a container, an application, etc.) that may provide a desired portion of the computer-implemented services.

Because the policies may be maintained by any number of other authentication systems (e.g., that may each be configured to maintain at least one policy for a respective component of the infrastructure), an ability of the authentication system to facilitate provisioning of desired computer-implemented services to be provided by the components may be negatively impacted. For example, the policies may not be consistently enforced due to conflicts between at least one of the policies. As such, policy enforcement gaps may result in security vulnerabilities for potential unauthorized access.

To resolve a potential conflict between policies for various components, the authentication system (e.g., a global authentication system) may collect at least one policy from the other authentication systems (e.g., local authentication systems). Once obtained, the authentication system may identify whether any conflicts exist between the at least one policy. For example, consider a scenario in which an orchestrator utilizes an authentication system that maintains a policy that grants a limited level of access (e.g., user level privilege) based on a user role (e.g., a developer role). While working cooperatively with the orchestrator, a continuous deployment service may maintain a separate authentication system that maintains a second policy that grants an elevated level of access (e.g., administrator level privilege) based on the same user role. The elevated privilege enforced based on the second policy may bypass the first policy resulting in a risk of authorized access and/or exposure of sensitive data.

The authentication system may identify the conflict by comparing sets of rules corresponding to the policies (e.g., to determine whether the sets of rules include mutually exclusive rules). Once identified as having a conflict, the authentication system may harmonize the policies to obtain a harmonized policy for use in identifying a level of privilege of the entity requesting the portion of computer-implemented services. To harmonize the policies, the authentication system may identify a desired set of rules using criteria (e.g., regulatory compliance, security restrictiveness, risk profile, etc.). For example, returning to the previous scenario, the authentication system may apply the lowest privilege level relative to data access for all components.

Once harmonized, the authentication system may identify whether the entity has sufficient privilege to initiate the desired portion of the computer-implemented services. To do so, the authentication system may utilize at least one authentication mechanism to process the privilege verification request. The authentication mechanism may include, for example, credential-based authentication (e.g., passwords), certificate-based authentication, token-based authentication, federated authentication (e.g., open authorization protocol), and/or any other methods for verifying an identify and/or a level of privilege of the entity.

To provide the above noted functionality, the system may include infrastructure 100, authentication system 102, and orchestrator 106. Each of these components is discussed below.

Infrastructure 100 may provide desired computer-implemented services. To do so, infrastructure may include any number of data processing systems (e.g., 110A-110N) that may cooperatively and/or independently provide the computer-implemented services. The data processing systems may each host various hardware and/or software resources (e.g., executing services) that may (i) enable users and/or other entities to request that various services be performed (e.g., via a user interface, application programming interface calls, etc.), (ii) cooperate with authentication system 102 and/or orchestrator 106 to authorize and queue performance of actions so that the requested services are provided, and/or perform any other actions. Infrastructure 100 may include, for example, a container orchestrated infrastructure in which data processing systems 110 host containers for running an application that provides a portion of the computer-implemented services.

Orchestrator 106 may provide management services for infrastructure 100. For example, orchestrator 106 may configure policies to be enforced for infrastructure 100 while providing the computer-implemented services, instruct services provided by infrastructure 100 to forward privilege verification requests to authentication system 102, and/or perform any other actions.

Authentication system 102 may provide privilege verification services. To provide the privilege verification services, authentication system 102 may obtain privilege verification requests from any entity (e.g., an application hosted by infrastructure 100, a user of a data processing system, etc.), obtain at least one policy based on a privilege verification request, identify conflicts between policies, harmonize policies to resolve identified conflicts, authorize provisioning of computer-implemented services based on identified levels of privilege, and/or perform any other actions. Authentication system 102 may obtain policies from any number of other authentication systems (not shown) that may each maintain separate policies for components of infrastructure 100.

To do so, authentication system 102 may host various software services such as, for example, authentication services, policy management services, and/or other types of services. For example, the authentication services and policy management services may utilize role-based access controls, store policies for managing workflows, and/or communicate with the other authentication systems to ensure that malicious actions are not performed due to unauthorized access.

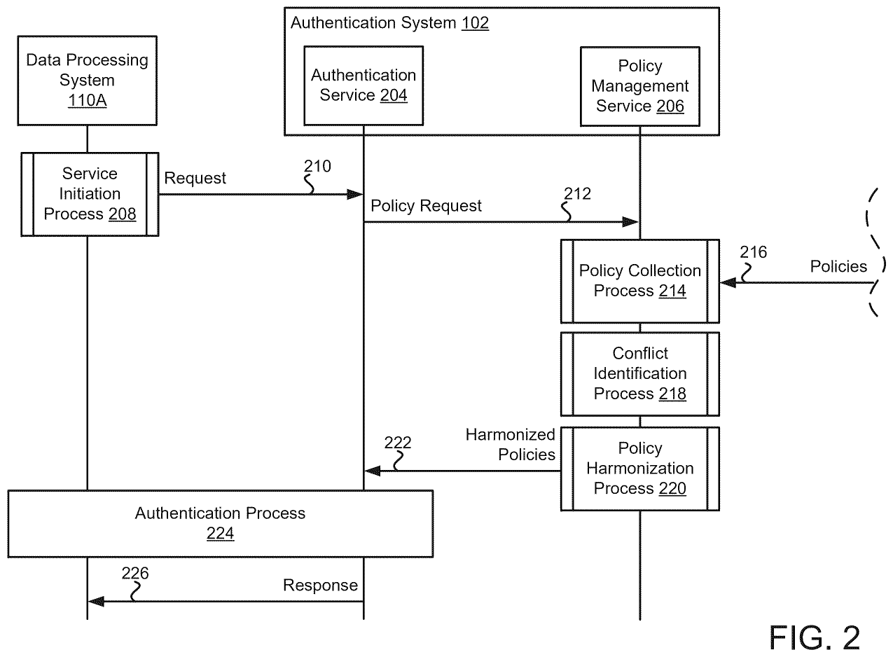

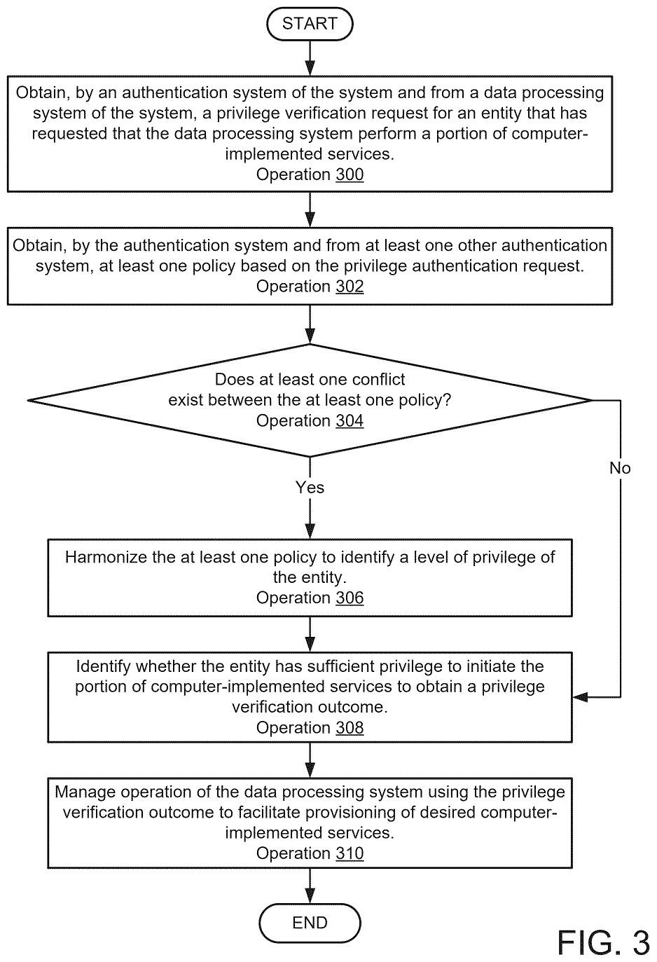

While providing their functionality, any of infrastructure 100, authentication system 102, and/or orchestrator 106 may provide all or a portion of the methods shown in FIGS. 2-3.

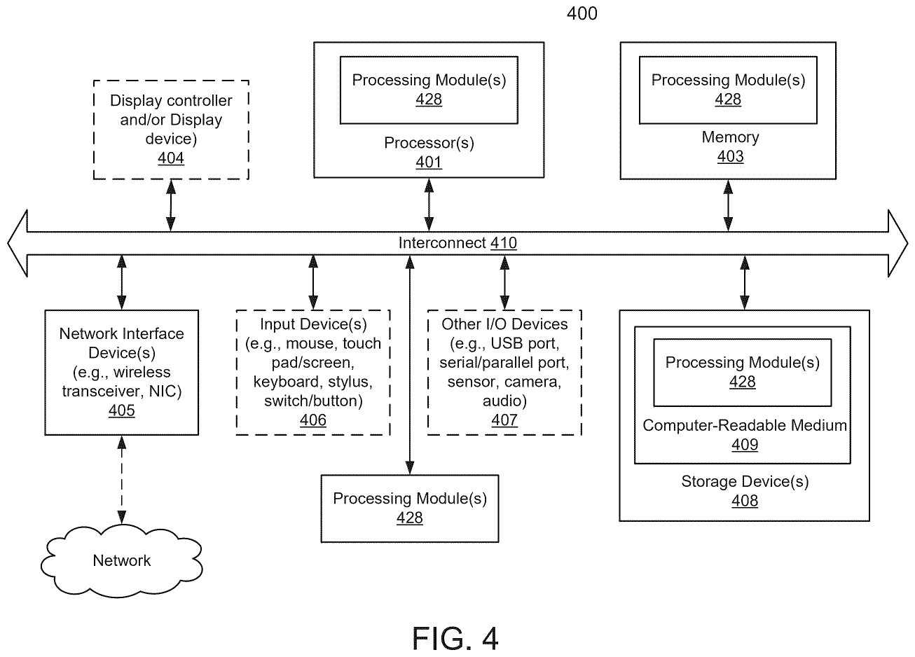

Communication system 104 may allow any of infrastructure 100, authentication system 102, and orchestrator 106 to communicate with one another (and/or with other devices not illustrated in FIG. 1). To provide its functionality, communication system 104 may be implemented with one or more wired and/or wireless networks. Any of these networks may be a private network (e.g., the “Network” shown in FIG. 4), a public network, and/or may include the Internet. For example, infrastructure 100 may be operably connected to authentication system 102 via the Internet. Infrastructure 100, authentication system 102, orchestrator 106 and/or communication system 104 may be adapted to perform one or more protocols for communicating via communication system 104.

Any of (and/or components thereof) data processing systems (e.g. 110A-110N), and authentication system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1, a system in accordance with an embodiment may be managed by obtaining policies based on a privilege verification request for an entity performance of a portion of computer-implemented services provided by the system. The policies may be harmonized in an instance where at least one conflict is identified between the policies to reduce a likelihood that the system may be compromised while providing the computer-implemented services.

While illustrated in FIG. 1 with a limited number of specific components, a system may include additional, fewer, and/or different components without departing from embodiments disclosed herein.

To further clarify embodiments disclosed herein, an interactions diagram in accordance with an embodiment are shown in FIG. 2. These interaction diagram may illustrate how data may be obtained and used within the system of FIG. 1.

In the interaction diagram, processes performed by and interactions between components of a system in accordance with an embodiment are shown. In the diagram, components of the system are illustrated using a first set of shapes (e.g., 110A, 204, etc.), located towards the top of each figure. Lines descend from these shapes. Processes performed by the components of the system are illustrated using a second set of shapes (e.g., 208, 214, etc.) superimposed over these lines. Interactions (e.g., communication, data transmissions, etc.) between the components of the system are illustrated using a third set of shapes (e.g., 210, 212, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 210 may occur prior to the interaction labeled as 212. However, it will be appreciated that the processes and interactions may be performed in different orders, any may be omitted, and other processes or interactions may be performed without departing from embodiments disclosed herein.

Turning to FIG. 2, a first interaction diagram in accordance with an embodiment is shown. The first interaction diagram may illustrate processes and interactions that may occur during privilege verification of an entity with respect to providing computer-implemented services based on policies.

To verify privilege of an entity with respect to providing computer-implemented services, service initiation process 208 may be performed. During service initiation process 208, an authentication request may be generated based on a request by an entity requesting performance of a portion of computer-implemented services. For example, the entity (e.g., a user, a software agent, etc.) may provide an input (e.g., click a button) via a user interface, invoke an application programming interface call, attempt to issue a command, and/or perform any other actions to request a service. As a result, a privilege verification request may be generated.

At interaction 210, the privilege verification request may be provided to authentication service 204. Authentication service 204 may be hosted by authentication system 102 and may include any number and/or type of software resources used to verify an identify of the entity requesting the service. For example, authentication service 204 may include one or more authentication modules (e.g., pluggable authentication modules), an authentication flow controller, and/or any other components. The privilege verification request may be provided to authentication service 204, for example, by redirecting transmission of the request to other authentication systems (not shown) associated with data processing system 110A and/or services hosted by data processing system 110A.

At interaction 212, a policy request may be generated and provided to policy management service 206 by authentication service 204. Policy management service 206 may be hosted by authentication system 102 and may provide any number and/or types of services regarding policies (e.g., authentication policies) for data access for components of infrastructure 100. For example, policy management service 206 may store policies in a centralized policy repository, communicate with other authentication systems and components to receive policies, and/or perform any other actions. By obtaining the policy request, policy management service may identify at least one policy based on the privilege verification request.

To identify the at least one policy, policy collection process 214 may be performed. During policy collection process 214, the at least one policy may be obtained from based on the privilege verification request. For example, to obtain the at least one policy, policy management service 206 may search a policy repository using an identify of the entity as a key, communicate with other authentication systems and other components of the system, and/or perform any other actions.

At interaction 216, the policies may be provided to authentication system 102 by the other authentication systems (not shown) that maintain local policies (e.g., specific to a certain component, container, application, etc.). The policies may be obtained by request from authentication system 102, redirected to authentication system 102 based on an initial privilege verification request from data processing system 110A, and/or via any other processes. Because the policies may be obtained from any number of sources (e.g., other authentication systems, orchestrator 106, etc.), at least one conflict may exist between the policies.

To identify whether a conflict exists, conflict identification process 218 may be performed. During conflict identification process 218, policies may be analyzed to identify at least one conflict between the policies. For example, to analyze the policies, rules and/or controls specified by each policy may be mapped to a corresponding rule, rules of one policy may be compared to rules of a second policy to identify contradictions, enforcement mechanisms (e.g., policy precedence, hierarchy, etc.) associated with the policies may be evaluated, and/or via any other processes. If identified that a conflict exists, policy management service 206 may proceed to resolve the conflicts between the policies.

To resolve the conflicts between the policies, policy harmonization process 220 may be performed. During policy harmonization process 220, a desired set of rules may be identified based on the policies and according to criteria. For example, to identify the desired set of rules, policy management service 206 may standardize terminology used in the policies, apply one set of rules across all policies (e.g., a lowest level of privilege, the most restrictive policy, etc.), evaluate compliance requirements, perform risk assessment tests, and/or perform any other actions. By doing so, a harmonized policy may be provided to authentication service 204, at interaction 222, be used to verify and/or enforce a level of privilege for the entity.

To verify and/or enforce the level of privilege for the entity, authentication process 224 may be performed. During authentication process 224, an authentication flow may be selected based on the policies, and authentication system 102 may cooperate with the entity to verify the request issued by the entity. For example, the authentication flow may be selected by identifying an authentication mechanism based on the harmonized policy and the using the privilege verification request. Once selected, authentication service 204 may initiate use of the authentication mechanism by validating credentials provided by the entity, prompting the entity to provide additional information, obtaining an access token from a third-party service (e.g., using an open authorization protocol) to be used for verification, generating and providing a multi-factor authentication code to the user for subsequent verification, and/or via any other processes.

At interaction 226, a response may be provided to data processing system 110A by authentication service 204. The response may include a generated token, a certificate, message, and/or any other information that may indicate a privilege verification outcome. The response may indicate, for example, that the privilege verification request was approved or denied. In the instance where the privilege verification request is approved, data processing system 110A may be allowed to initiate provisioning of the desired portion of computer-implemented services while adhering to the harmonized policies identified by authentication system 102. In a second instance where the privilege verification request is denied, data processing system 110A may prevent the computer-implemented services from being performed, restrict further actions by the entity, and/or perform any other remediation actions.

Thus, using the flow shown in FIG. 2, embodiments disclosed herein may facilitate provisioning of computer-implemented services in a manner that is less likely to result in compromise of various infrastructure components by using an authentication system to identify potential conflicts between policies (e.g., maintained by other authentication systems) based on a privilege verification request and harmonizing the policies to resolve the potential conflicts.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data processing systems. FIG. 3 illustrates a method that may be performed by the components of the system of FIG. 1. In the diagrams discussed below and shown in FIG. 3, any of the operations may be repeated, performed in different orders, and/or performed in parallel with or in a partially overlapping in time manner with other operations.

Turning to FIG. 3, a flow diagram illustrating a method for managing a system in accordance with an embodiment is shown. The method may be performed, for example, by any of the components of the system of FIG. 1, and/or other components not shown therein.

At operation 300, a privilege verification request may be obtained by an authentication system and from a data processing system for an entity that has requested that the data processing system perform a portion of computer-implemented services. The privilege verification request may be obtained by: (i) entering, by the entity (e.g., a user), a unique resource locator address in an internet browser, (ii) clicking a button in a user interface of an application hosted by the data processing system, (iii) invoking an application programming interface function that may send a request (e.g., header, message, etc.), and/or via any other processes.

At operation 302, at least one policy may be obtained by the authentication system based on the privilege authentication request. The at least one policy may be obtained by: (i) sending a request to fetch the at least one policy from the other authentication systems, (ii) performing a lookup in a policy repository, (iii) broadcasting a communication to other authentication systems to establish a communication channel for transmitting the policies, and/or via any other processes.

At operation 304, an identification may be made regarding whether at least one conflict exists between the at least one policy. The identification may be made by: (i) processing the policies using a security policy management tool to identify redundancies in rules, (ii) performing policy simulations to get results that may indicate that the policies may have conflicted, (iii) mapping the policies based on a type of the policies to identify overlaps, and/or performing any other actions. If the conflict is identified to exist (e.g., the identification is “Yes” at operation 304), the method may proceed to operation 306. If the conflict is not identified to exist (e.g., the identification is “No” at operation 304), the method may proceed to operation 308.

At operation 306, the at least one policy may be harmonized to identify a level of privilege of the entity. The at least one policy may be harmonized by: (i) aggregating the policies according to criteria (e.g., a weighting algorithm, voting process, etc.), (ii) prioritizing a set of rules defined by a policy based on risk and/or impact, (iii) merging overlapping policies to obtain a single comprehensive policy, (iv) applying the more restrictive policy (e.g., a lower level of privilege) to all other policies, and/or via any other processes.

At operation 308, it may be identified whether the entity has sufficient privilege to initiate the portion of computer-implemented services to obtain a privilege verification outcome. It may be identified whether the entity has sufficient privilege by: (i) validating a password provided by the entity using a hashing algorithm, (ii) obtaining an event-based one time password generated by a hardware token device connected to the data processing system, (iii) generating a software token and providing the token to the entity for subsequent verification, and/or via any other processes.

At operation 310, operation of the data processing system may be managed using the privilege verification outcome to facilitate provision of desired computer-implemented services. The operation of the data processing system may be managed by: (i) initiating performance of the desired portion of the computer-implemented services, (ii) granting data access to the entity for a specified level of privilege (e.g., role-based access, session length, etc.), (iii) restricting operation of the data processing system (e.g., in the instance that the privilege verification outcome indicates that the entity is a malicious entity), and/or performing any other actions.

The method may end following operation 310.

Using the method shown in FIG. 3, operation of system may be managed by using a structured authentication framework to identify a level of privilege of an entity based on a privilege verification request. By doing so, a data processing system and/or other components of the system may be less likely to be compromised while providing computer-implemented services based on a request by the entity.

Any of the components illustrated in FIGS. 1-2 may be implemented with one or more computing devices. Turning to FIG. 4, a block diagram illustrating an example of a data processing system (e.g., a computing device) in accordance with an embodiment is shown. For example, data processing system 400 may represent any of data processing systems described above performing any of the processes or methods described above. Data processing system 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that data processing system 400 is intended to show a high level view of many components of the computer system. However, it is to be understood that additional components may be present in certain implementations and furthermore, different arrangement of the components shown may occur in other implementations. Data processing system 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, data processing system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. Data processing system 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Data processing system 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of data processing system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by data processing system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while data processing system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a system that provides computer-implemented services, the method comprising:
obtaining, by an authentication system of the system and from a data processing system of the system, a privilege verification request for an entity that has requested that the data processing system perform a portion of the computer-implemented services;
obtaining by the authentication system and from at least one other authentication system, at least one policy based on the privilege verification request;
identifying whether any conflicts between the at least one policy exists;
in a first instance of the identifying where at least one conflict between the at least one policy exists:
harmonizing the at least one policy to identify a level of privilege of the entity;
identifying whether the entity has sufficient privilege to initiate the portion of the computer-implemented services using the identified level of privilege of the entity to obtain privilege verification outcome; and
managing operation of the data processing system using the privilege verification outcome to facilitate provisioning of desired computer implemented services.

2. The method of claim 1, wherein the authentication system is adapted to use at least one authentication mechanism to process the privilege verification request.

3. The method of claim 2, wherein the at least one authentication mechanism comprises at least one selected from a list of authentication mechanisms consisting of:
credential-based authentication;
certificate-based authentication;
token-based authentication; and
federated authentication.

4. The method of claim 1, wherein the at least one other authentication system maintains at least one local policy used to define a level of privilege for at least one data processing system of the system.

5. The method of claim 4, wherein the authentication system communicates with the at least one other authentication system to obtain the at least one local policy based on the privilege verification request.

6. The method of claim 1, wherein identifying whether the at least one conflict exists comprises:
comparing a set of rules corresponding to a first policy of the at least one policy to a second set of rules corresponding to a second policy of the at least one policy;
making a determination regarding whether the first set of rules and the second set of rules comprises at least one mutually exclusive rule; and
in a first instance of the determination where the first set of rules and the second set of rules does comprise at least one mutually exclusive rule:
concluding that the policy conflict exists.

7. The method of claim 6, wherein harmonizing the at least one policy comprises:
identifying a desired set of rules, between the first set of rules and the second set of rules, using criteria; and
defining a harmonized set of security policies using the desired set of rules.

8. The method of claim 7, wherein the criteria comprise a lowest level of privilege for data access.

9. The method of claim 1, wherein identifying whether the entity has sufficient privilege comprises:
identifying a predefined authentication flow based on the privilege verification request and the level of privilege of the entity; and
verifying the privilege verification request using the predefined authentication flow to obtain the privilege verification outcome.

10. A non-transitory machine-readable medium having instructions stored therein, which when executed by a processor, cause the processor to perform operations for managing operation of a system that provides computer-implemented services, the operations comprising:
obtaining, by an authentication system of the system and from a data processing system of the system, a privilege verification request for an entity that has requested that the data processing system perform a portion of the computer-implemented services;
obtaining by the authentication system and from at least one other authentication system, at least one policy based on the privilege verification request;
identifying whether any conflicts between the at least one policy exists;
in a first instance of the identifying where at least one conflict between the at least one policy exists:
harmonizing the at least one policy to identify a level of privilege of the entity;
identifying whether the entity has sufficient privilege to initiate the portion of the computer-implemented services using the identified level of privilege of the entity to obtain privilege verification outcome; and
managing operation of the data processing system using the privilege verification outcome to facilitate provisioning of desired computer implemented services.

11. The non-transitory machine-readable medium of claim 10, wherein the authentication system is adapted to use at least one authentication mechanism to process the privilege verification request.

12. The non-transitory machine-readable medium of claim 11, wherein the at least one authentication mechanism comprises at least one selected from a list of authentication mechanisms consisting of:
credential-based authentication;
certificate-based authentication;
token-based authentication; and
federated authentication.

13. The non-transitory machine-readable medium of claim 10, wherein the at least one other authentication system maintains at least one local policy used to define a level of privilege for at least one data processing system of the system.

14. The non-transitory machine-readable medium of claim 13, wherein the authentication system communicates with the at least one other authentication system to obtain the at least one local policy based on the privilege verification request.

15. The non-transitory machine-readable medium of claim 10, wherein identifying whether the at least one conflict exists comprises:
comparing a set of rules corresponding to a first policy of the at least one policy to a second set of rules corresponding to a second policy of the at least one policy;
making a determination regarding whether the first set of rules and the second set of rules comprises at least one mutually exclusive rule; and
in a first instance of the determination where the first set of rules and the second set of rules does comprise at least one mutually exclusive rule:
concluding that a conflict exists.

16. A data processing system, comprising:
a processor; and
a memory coupled to the processor to store instructions, which when executed by the processor, cause the processor to perform operations for managing operation of system that provides computer-implemented services, the operations comprising:
obtaining, by an authentication system of the system and from a data processing system of the system, a privilege verification request for an entity that has requested that the data processing system perform a portion of the computer-implemented services;
obtaining by the authentication system and from at least one other authentication system, at least one policy based on the privilege verification request;
identifying whether any conflicts between the at least one policy exists;
in a first instance of the identifying where at least one conflict between the at least one policy exists:
harmonizing the at least one policy to identify a level of privilege of the entity;
identifying whether the entity has sufficient privilege to initiate the portion of the computer-implemented services using the identified level of privilege of the entity to obtain privilege verification outcome; and
managing operation of the data processing system using the privilege verification outcome to facilitate provisioning of desired computer implemented services.

17. The system of claim 16, wherein the authentication system is adapted to use at least one authentication mechanism to process the privilege verification request.

18. The system of claim 17, wherein the at least one authentication mechanism comprises at least one selected from a list of authentication mechanisms consisting of:
credential-based authentication;
certificate-based authentication;
token-based authentication; and
federated authentication.

19. The system of claim 18, wherein the at least one other authentication system maintains at least one local policy used to define a level of privilege for at least one data processing system of the system.

20. The system of claim 19, wherein the authentication system communicates with the at least one other authentication system to obtain the at least one local policy based on the privilege verification request.
